(19) United States
(12) Patent Application Publication
(10) Pub. No.: US 2005/0050269 A1
(43) Pub. Date: Mar. 3, 2005

(54) Method of collecting and tallying operational data using an integrated I/O controller in real time

(76) Inventor: Robert L. Horn, Yorba Linda, CA (US)

Correspondence Address: DICKSTEIN SHAPIRO MORIN & OSHINSKY LLP, 2101 L Street, NW, Washington, DC, 20037, US

(21) Appl. No.: 10/713,189

(22) Filed: Nov. 17, 2003

Related U.S. Application Data
(60) Provisional application No. 60/497,906, filed on Aug. 27, 2003.

(51) Int. Cl. G06F 12/00

(52) U.S. Cl. 711/114; 711/113; 711/154

(57) ABSTRACT

A storage statistics collection system that continuously monitors and collects data associated with read and write commands issued from a host processor. Parameters collected may include, for example, the total read sectors, the total write sectors, the total number of read commands, the total number of write commands, and system latencies. Displays and reports, such as histograms based on the collected data, provide a visualization of system performance characteristics.

This application claims the benefit of U.S. Provisional Application No. 60/497,906, filed Aug. 27, 2003, the content of which is herein incorporated by reference in its entirety.

### FIELD OF INVENTION

The present invention relates to storage systems. In particular, this invention relates to a real-time method of collecting operational data for a storage system.

### BACKGROUND OF THE INVENTION

Storage system configurations have been used for years to protect data and applications. Configurations for storage systems include a number of storage elements and a specialized transaction processor/virtualizer. In some instances storage systems are attached to networks instead of being directly attached to hosts. Such storage systems are known as network storage systems.

The collection and analysis of operational data within storage systems is an important aspect of the successful implementation of these systems. This data is critical for generating system performance statistics, producing quality of service statistics, producing latency statistics, and providing data to algorithms used in load balancing and storage element usage optimization. Operational data is also used to tune storage systems and perform cost analysis on data processing operations. Unfortunately, conventional data acquisition strategies, such as periodic sampling, are able to collect data only at regularly scheduled intervals. Particularly when the data is being used for performance feedback algorithms, this delay in data collection and transfer often results in system inefficiencies and system performance degradation. While conventional storage systems are not precluded from real-time sampling, the resulting processing overhead more than negates any performance advantages of a tighter control loop.

Conventional storage systems are unable to collect operational data in real time without significant system-level processor burden. The conventional approach has been to only collect data at scheduled intervals after the data is generated. The time delay between when an operation is performed and when the data for that operation is available for analysis can limit the ability of tuning algorithms to optimize system performance, resulting in compromised system performance. Furthermore, because of buffer and processor requirements, operational data collection in conventional networked storage systems may cause serious performance degradations, resulting in increased data transfer times or longer command processing latencies. It would be desirable to collect networked storage system operational data in real time without significant performance degradation.

After operational data is collected, it must be ordered in a fashion that renders it suitable for statistical analysis. This might include binning the raw data, aggregating data, filtering data, etc. Conventional networked storage systems collect raw operational data but are unable to bin or summarize operational data in real time, resulting in long time lags between raw data collection and data analysis. This time lag may adversely affect system optimization tasks, such as load balancing and storage element mapping. It would be desirable to organize networked storage system operational data in real time.

U.S. Pat. No. 5,729,397, entitled, “SYSTEM AND METHOD FOR RECORDING DIRECT ACCESS STORAGE DEVICE OPERATING STATISTICS,” describes a disk drive that includes an error and operating condition tracking mechanism for later analysis. A device controller for the disk drive has access to non-volatile storage. The non-volatile storage is partitioned into one or more areas for storage of condition and error information. A main partition is used for storage of cumulative operating statistics. A secondary partition is used for logging time-stamped condition records, with the accumulative count register being used to provide the time stamp. A last-in, last-out partition is used by the device controller to store time-stamped error occurrence records for the data storage system.

While the storage system described in the '397 patent provides a method of tracking operating statistics of disk drives, the '397 patent does not provide a way to collect and organize storage system operational data in real time.

It is therefore an object of the invention to provide a system and method for collecting networked storage system operational data in real time without significant performance degradation.

It is another object of this invention to provide a system and method for organizing networked storage system operational data in real time.

### SUMMARY OF THE INVENTION

The present invention is a system and method for collecting real-time statistics in hardware-based storage systems. Such systems include, but are not limited to, individual redundant array of independent disks (RAID) or “just a bunch of disks” (JBOD) systems, storage area networks (SAN), network attached storage (NAS), automated tape libraries, and storage virtualization systems. From a number of locations, the statistics collection system continuously monitors and collects data associated with read and write commands issued from a host processor. Parameters collected may include, for example, the total read sectors, the total write sectors, the total number of read commands, the total number of write commands, and system latencies. Displays and reports, such as histograms based on the collected data, provide a visualization of system performance characteristics.

### BRIEF DESCRIPTION OF THE DRAWINGS

The foregoing and other advantages and features of the invention will become more apparent from the detailed description of exemplary embodiments of the invention given below with reference to the accompanying drawings, in which:

FIG. 1 illustrates one embodiment of a networked storage system including a statistics collection system for real-time statistics collection in accordance with the principles of the present invention; and

FIG. 2 illustrates one embodiment of a method of collecting real-time statistics in accordance with the principles of the present invention.

### DETAILED DESCRIPTION OF THE PREFERRED EMBODIMENT

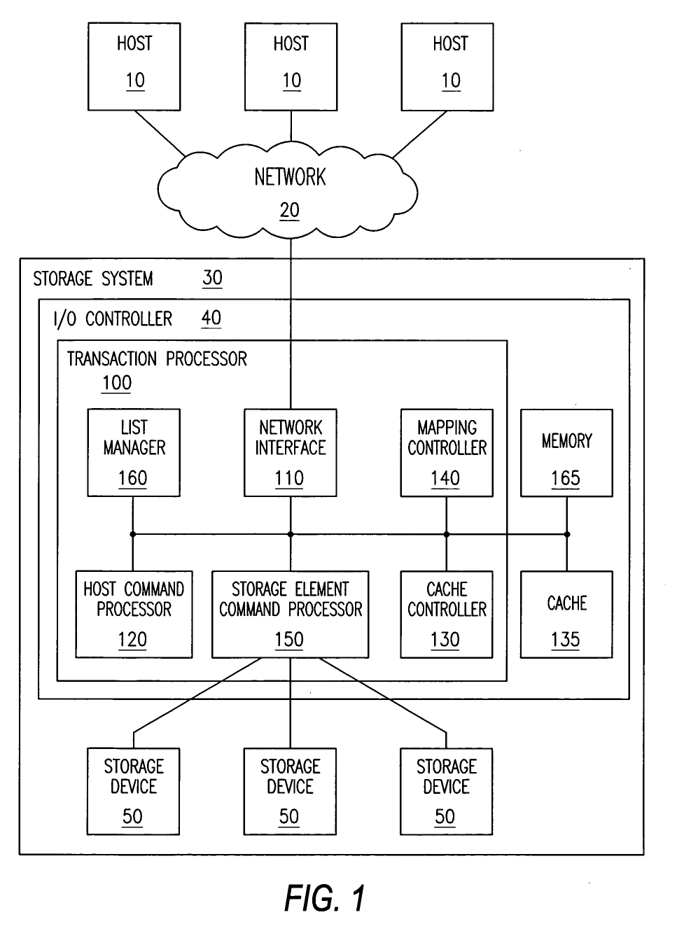

Now referring to the drawings, where like reference numerals designate like elements, there is shown in FIG. 1 a system 1. The system 1 includes at least one host 10 which is in communication with a storage system 30. Host 10 typically contains memory (not shown), fixed storage (not shown), input and output functionality (not shown), and one or more CPUs (not shown). In FIG. 1, the host 10 communicates with the storage system 30 over a network 20, and therefore the storage system 30 is generally known as a network storage system. As illustrated, there is a single connection between the network interface 110 and the network 20. However, in other embodiments there may be plural network connections to corresponding plural network storage segments. The plural network connections may be implemented using any combination of plural network interfaces 110, or a single network interface 110 having plural connectors. Depending certain details regarding how the storage system 30 is networked and accessed, the storage system 30 may also be known as a network attached storage (NAS), a storage area network (SAN), or a storage routers, etc. However, it should be understood that the principles of the present invention are also applicable if the storage system 30 is directly attached to one or more hosts 10, for example, via fiber channel (FC), SCSI, or channel links.

As illustrated, the storage system 30 includes an I/O controller 40, a transaction processor 100 (such as described in U.S. Patent Publication No. 2003/0195918, incorporated herein by reference) contained within I/O controller 40, and a plurality of storage devices 50. The use of plural storage devices 50 permit the storage system 30 to employ redundancy, such as the well known RAID and mirroring techniques to ensure reliable access to data. Additionally, different portions of the plural storage devices 50 may also be viewed by the hosts 10 as one or more independent logical volumes. The storage devices 50 are each coupled to the transaction processor 100. As illustrated in FIG. 1, the storage devices 50 are each coupled to the transaction processor 100 via independent links. However, in other embodiments, there may be plural storage devices coupled to the transaction processor 100 via links or loops (e.g., fiber channel arbitrated loops, (FC-AL)). In one embodiment, there are plural loops each having one or more storage devices 50. The transaction processor 100 is also coupled to the network 20. Thus, hosts 10 access the information contained in the storage devices 50 of the storage system through the transaction processor 100 of the I/O controller 40 contained in the storage system.

In one exemplary embodiment, the transaction processor 100 is comprised of several components, including a network interface 110, a host command processor 120, a cache controller 130, a mapping controller 140, a storage element command processor 150, and a list manager 160. Each of the above listed components are coupled to a bus, cross-plane switch or other means in order to permit communication among the components.

The network interface 110 is the component of the transaction processor 100 used to facilitate communication between the storage system 30 and the network 20. All incoming and outgoing network traffic is routed through the network interface 110. If the storage system 30 is not a network storage system, the network interface 110 can be replaced by a host interface, which would instead route data and commands between the transaction processor and the communication medium coupling the storage system 30 to a host 10 (e.g., a channel).

The host command processor 120 is the component of the transaction processor 100 which receives host commands (via the network interface 110). The host commands are decoded by the host command processor 120, which determines whether the requested host command can be serviced by accessing a cache memory 135 within I/O controller 40. The host command processor 120 also communicates with the mapping controller 140.

The cache memory 135 is a high speed memory used to temporarily store read or write data, since data stored in the cache 135 can be accessed much faster than servicing an access request to a storage device 50. In the preferred illustrated embodiment, the cache 135 is just a memory, contained within I/O controller 40, but external to the transaction processor 100, and is managed by cache controller 130 within transaction processor 100. In another exemplary embodiment, the cache 130 is a self managed cache memory system having the memory as well as a cache controller.

The mapping controller 140 is used to translate host addresses to storage device addresses, since the hosts 10 see the storage system 30 as one or more independent logical volumes. The hosts 10 therefore issue read and write commands to the logical volumes addressed using, for example, a logical volume number and a logical block address. The mapping controller 140 is utilized to convert between the logical addresses used by the hosts 10 and the physical addresses used by the storage devices 50. If the storage system 30 utilizes redundancy information to increase reliability, (e.g., the storage system is a disk array using RAID), the mapping controller 140 is also used to map between logical addresses and redundancy groups (e.g., stripes).

The storage element command processor 150 is used to issue commands to, and to send/receive data to/from the storage devices 50 of the storage system 30. The storage element command processor 150 issues commands to the storage devices 50 using the addressing format of the storage devices 50.

A memory 165 within the I/O controller 40, but external to the transaction processor 100, is used by the invention for maintaining storage system statistics. The use of the memory 165 will be described in greater detail below. It should be noted that while the memory 165 is illustrated and described as a component external to the transaction processor 100, the invention may also be practiced by integrating the memory 165 into one of the other components, such as the host command processor 120.

In operation, a host 10 transmits to the storage system 30 a command to read or write a logical volume. The command include the read or write command itself, as well as a logical address. The logical address is typically a combination of one or more of the following: a host address identifying the host issuing the command, a port number identifying a physical interface on the host which is used to issue the command, a logical unit number identifying a logical volume, and a logical block address (LBA) within the logical volume. The command is transmitted via the network 20 to the network interface 110, and then to the host command processor 120 of the transaction processor 100. The host command processor 120 accepts the read or write command as input, and collects and records a data set of statistics. In one embodiment, the data set is known as data set 1-8, and includes, from the submitted read or write command, the following components: (1) the number of reads, (2) the number of writes, (3) the sectors read, (4) the sectors written, (5) the time to write data, (6) the time to read data, (7) the time to complete the write, and (8) the time to complete the read. Host command processor 120 collects this data set for each host 10, for each logical volume, and for each host port. The above described data set is stored in the memory 165. The cache controller 130 then collects and records a ninth piece of data (the cache hit/miss type) and adds it to data set 1-8. The cache hit/miss type portion of the data set 1-8 is also stored in the memory 165.

The mapping controller 140 generates the storage element commands by converting logical addresses to physical addresses info individual storage element commands. Storage element command processor 150 collects and records data set 1-8 for each individual storage element and storage element loop.

After data set 1-8 is collected at all points, a list is created that contains a tally for all write and read commands. Write commands are tallied as full hit writes when written over dirty data, as full hit overwrites when written over valid data, or as full misses when new cache segments are allocated for the command. Read commands are tallied as predictive read hits, repetitive read hits, or full misses. The tally may be generated in real time as commands are processed or compiled on a scheduled maintenance interval.

From the tally, a histogram is then created for each host 10, for each volume, and for each host port. In one exemplary embodiment, the histogram is a eight-bin histogram. The histogram is created by a assigning a time stamp to both the issuance of the command by host 10 and the reception of the command by host command processor 120. The difference between the time stamps is then calculated and the histogram is incremented accordingly. Further, a time stamp is recorded when a command is completed, and the histogram is incremented accordingly. For example, when a read command is issued by host 10, host command processor 120 records the time that the read command is issued and the time that the command is received. After the read command is completed, host command processor 120 records the elapsed time and adjusts the appropriate bin of the histogram.

The resulting 8-bit histogram may be viewed in real time. The following performance characteristics of the networked storage system can be derived from the histogram: (1) performance of the storage elements relative to expected performance, (2) volume performance, (3) utilization of storage element loops, and (4) cache tuning performance (e.g., hit rates, partial hit rates, etc.). In addition, the data supporting the 8-bin histograms can be used to produce quality of service statistics, such as command input and output rates, data transfer rates, and latency statistics.

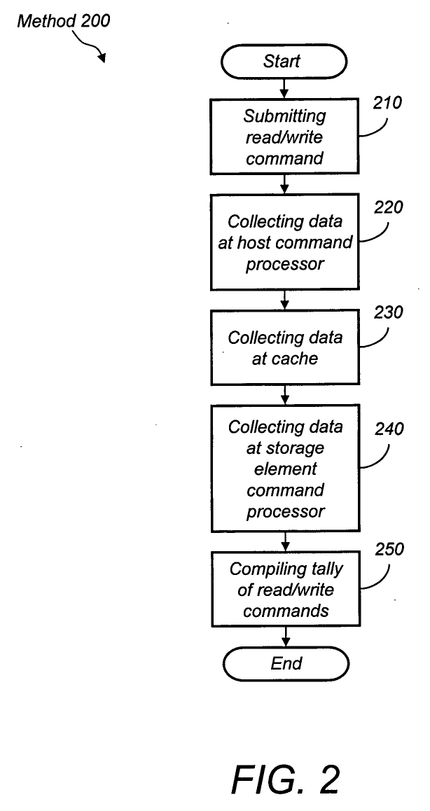

FIG. 2 illustrates a method 200 of real-time statistics collection in hardware-based networked storage systems. Method 200 includes the following steps:

Step 210: Submitting read/write command

In this step, a host 10 submits to host command processor 120 a command to read or write a logical volume. In one exemplary embodiment, the command is submitted via the network 20 and arrives at the host command processor 120 after passing through a network interface 110. Method 200 proceeds to step 220.

Step 220: Collecting data at host command processor

In this step, host command processor 120 accepts as input the read or write command submitted in step 210, and collects and records the previously mentioned data set known as data set 1-8. The host command processor 120 collects this data set for each host 10, for each logical volume, and for each host port. Method 200 proceeds to step 230.

Step 230: Collecting data at cache

In this step, cache controller 130 collects and records the cache hit/miss type and adds it to the data set 1-8 collected in step 220. Method 200 proceeds to step 240.

Step 240: Collecting data at storage element command processor

In this step, storage element command processor 150 collects and records data set 1-8 for each individual storage element and storage element loop. Method 200 proceeds to step 250.

Step 250: Compiling tally of read/write commands

In this step, when host read and write commands are completed, the statistics gathered during the processing of the read/write commands are incorporated into running totals maintained for a plurality of categories. In one exemplary embodiment, these include the following: (1) host, (2) host port, (3) logical (i.e., host) volume, (4) physical (i.e., storage device) volume, (5) networked storage segment, (6) storage element loop, and (7) storage element. The totals are maintained independently for read and write commands, and include command count, sector count, time-to-data histogram, and time-to-complete histogram. Write commands are tallied as full hit writes when written over dirty data, as full hit overwrites when written over valid data, or as full misses when new cache segments are allocated for the command. Read commands are tallied as predictive read hits, repetitive read hits, or full misses. The tally may be generated in real time as commands are processed or may be compiled on a scheduled maintenance interval. Method 200 ends.

Thus, the present invention provides for an apparatus and mechanism collecting storage system statistics in real time. More specifically, certain components of a controller normally used to operate the storage system are programmed to also gather statistics. The gathered statistics can also be quickly analyzed and a report, such as a histogram, be produced. Host side I/O activity can be typically identified by the qualifiers are the port (physical interface), the logical unit number (LUN), and the host. On the storage element side of the storage system, statistics are collected for every disk drive's interface port.

While the invention has been described in detail in connection with the exemplary embodiment, it should be understood that the invention is not limited to the above disclosed embodiment. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

1. A storage system, comprising:
a plurality of storage devices;
a cache;
a memory; and
a storage controller coupled to said plurality of storage devices and comprising:
an storage device interface, wherein said plurality of storage devices are coupled to said storage controller at said storage device interface;
a host interface, wherein said storage controller is connectable to at least one host via said host interface;
means for processing host commands, coupled to said storage device interface, said host interface, said cache and said memory,
wherein, when said means for processing host commands processes a host command for reading or writing to said storage devices, said means for processing host commands also records statistics associated with a processing of said host commands in said memory.

2. The storage system of claim 1, wherein said means for processing host commands records statistics by maintaining a plurality of numeric values and a plurality of time stamps.

3. The storage system of claim 2, wherein a first one of said numeric values relates to a number of read commands received by said means for processing host commands and said means for processing host commands increments said first one of said numeric values when a new read command is received by said means for processing host commands.

4. The storage system of claim 3, wherein said means for processing host commands records a time when said new read command is received in a first one of said plurality of time stamps.

5. The storage system of claim 4, wherein
a second one of said numeric values relates to a number of storage units read and
if said means for processing host command causes said storage device interface to read one or more storage units from said plurality of storage devices, said means for processing host commands increments said second one of said numeric values by a number of storage units read by said storage device interface to process said new read command.

6. The storage system of claim 5, wherein said means for processing host commands records in a second one of said plurality of time stamps a time when said number of storage units were read by said storage device interface to process said new read command.

7. The storage system of claim 6, wherein said means for processing host commands calculates a time to read data associated with said new read command as a difference between said first one and said second one of said plurality of time stamps, and records said time in a third one of said plurality of time stamps.

8. The storage system of claim 7, wherein said means for processing host commands records in a fourth one of said plurality of time stamps a time when data corresponding to said new read command is communicated to a host via said host interface.

9. The storage system of claim 8, wherein said means for processing host commands calculates a time to complete a new read command as a difference between said first one and said fourth one of said plurality of time stamps.

10. The storage system of claim 2, wherein a first one of said numeric values relates to a number of write commands received by said means for processing host commands and said means for processing host commands increments said first one of said numeric values when a new write command is received by said means for processing host commands.

11. The storage system of claim 10, wherein said means for processing host command records a time when said new write command is received in a first one of said plurality of time stamps.

12. The storage system of claim 11, wherein
a second one of said numeric values relates to a number of storage units written and
if said means for processing host commands causes said storage device interface to write one or more storage units from said plurality of storage devices, said means for processing host commands increments said second one of said numeric values by a number of storage units read by said storage device interface to process said new write command.

13. The storage system of claim 12, wherein said means for processing host commands records in a second one of said plurality of time stamps a time when said number of storage units were written by said storage device interface to process said new write command.

14. The storage system of claim 13, wherein said means for processing host commands calculates a time to write data associated with said new write command as a difference between said first one and said second one of said plurality of time stamps, and records said time in a third one of said plurality of time stamps.

15. The storage system of claim 14, wherein said means for processing host commands records in a fourth one of said plurality of time stamps a time when data corresponding to said new write command is communicated to a host via said host interface.

16. The storage system of claim 15, wherein said means for processing host commands calculates a time to complete a new write command as a difference between said first one and said fourth one of said plurality of time stamps.

17. The storage system of claim 2, wherein one of said numeric values relates to a number of cache hits, and said means for processing host commands increments said first one of said numeric values when processing a new read command or a new write command results in a cache hit.

18. The storage system of claim 2, wherein one of said numeric values relates to a number of cache hits, and said means for processing host commands increments said first one of said numeric values when processing a new read command or a new write command results in a cache miss.

19. The storage system of claim 2, wherein one of said numeric values relates to a number of cache hits, and said means for processing host commands increments said first one of said numeric values when processing a new read command results in a cache miss.

20. The storage system of claim 2, wherein one of said numeric values relates to a number of cache hits, and said means for processing host commands increments said first one of said numeric values when a processing a new write command results in a cache miss.

21. The storage system of claim 1, wherein said means for processing host commands records independent sets of statistics for each one of a plurality of hosts which issue commands to said storage system.

22. The storage system of claim 21, wherein said means for processing host command records independent sets of statistics for each host port of a given host.

23. The storage system of claim 1, wherein said means for processing host commands records independent sets of statistics for each host volume.

24. The storage system of claim 1, wherein said means for processing host commands records independent sets of statistics for each network storage segment.

25. The storage system of claim 1, wherein said means for processing host commands records independent sets of statistics for each storage element loop.

26. The storage system of claim 1, wherein said means for processing host commands records independent sets of statistics for each storage element.

27. A method for collecting and generating statistical data for a storage system, comprising:
receiving a command, said command being a read command or a write command;
processing said command;
while processing said command, collecting and storing operational statistics regarding said command at each one of a plurality of steps which comprise said processing.

28. The method of claim 27, wherein said command is a read command and said step of collecting and storing operational statistics includes incrementing a count of a number of read commands received.

29. The method of claim 27, wherein said step of collecting and storing operational statistics includes storing a time of when the read command was received.

30. The method of claim 27, wherein said step of collecting and storing operational statistics includes incrementing, by a number of storage units read while processing said read command, a count of a total number of storage units read.

31. The method of claim 27, wherein said step of collecting and storing operational statistics includes storing a time of when said number of storage units were read while processing said read command.

32. The method of claim 27, wherein said step of collecting and storing operational statistics includes storing a time of when read data is transmitted in response to said read command.

33. The method of claim 27, wherein said command is a write command and said step of collecting and storing operational statistics includes incrementing a count of a number of write commands received.

34. The method of claim 27, wherein said step of collecting and storing operational statistics includes storing a time of when the write command was received.

35. The method of claim 27, wherein said step of collecting and storing operational statistics includes incrementing, by a number of storage units written while processing said write command, a count of a total number of storage units written.

36. The method of claim 27, wherein said step of collecting and storing operational statistics includes storing a time of when said number of storage units were written while processing said write command.

37. The method of claim 27, wherein said step of collecting and storing operational statistics includes storing a time of when write data is transmitted in response to said write command.

38. The method of claim 27, wherein said step of collecting and storing operational statistics includes incrementing a cache hit counter whenever processing said command results in a cache miss.

39. The method of claim 27, wherein said step of collecting and storing operational statistics includes incrementing a cache miss counter whenever processing and command results in a cache miss.

40. The method of claim 27, wherein said step of collecting and storing operational statistics is independently performed for each host.

41. The method of claim 27, wherein said step of collecting and storing operational statistics is independently performed for each port of each host.

42. The method of claim 27, wherein said step of collecting and storing operational statistics is independently performed for each host volume.

43. The method of claim 27, wherein said step of collecting and storing operational statistics is independently performed for each network segment.

44. The method of claim 27, wherein said step of collecting and storing operational statistics is independently performed for each storage element loop.

45. The method of claim 27, wherein said step of collecting and storing operational statistics is independently performed for each storage element.
